(19) United States
(12) Patent Application Publication
(10) Pub. No.: US 2008/0229261 A1
(43) Pub. Date: Sep. 18, 2008

(54) DESIGN RULE SYSTEM FOR VERIFYING AND ENFORCING DESIGN RULES IN SOFTWARE

(75) Inventors: Sriram K. Rajamani, Bangalore (IN); Madhu Gopinathan, Bangalore (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/687,072

(22) Filed: Mar. 16, 2007

(51) Int. Cl. G06F 17/50

(52) U.S. Cl. 716/5

(57) ABSTRACT

A software design rule system is provided. The software design rule system can employ a rule language that enables software developers to model valid interactions between multiple, inter-related objects; provide a rule verifier component that determines whether design rules achieve their intended purpose; and provide a rule enforcer component that determines whether the software complies with the specified rules. Software designers can provide design specifications using the rule language that the software design rule system employs. The rule language can specify a program that identifies “auxiliary states” associated with objects in the software that is being developed, transitions between the auxiliary states, and object invariants.

### BACKGROUND

In large software development projects, software designers write a design specification that they or other software developers may refer to when writing source code for the software that implements the designs. These design specifications sometimes contain design decisions, such as interactions between various objects. An object is a basic building block in object-oriented programming. The design decisions can be expressed as design rules that impose constraints on the structure or behavior of the software. The design rules are sometimes expressed informally, such as in source code comments, design documents, and so forth.

The software can change over time, such as when fixing bugs, adding features, and so forth. During these changes, the software may fail to comply with the design decisions because the software developers or designers may no longer refer to the original design specification. Moreover, the software designers may fail to update the design specifications as the software changes. These failures may lead to various defects in the software, such as incompatibility with other software, interaction problems between objects, and so forth. These defects may not be found until late in the software testing process or until the product has been shipped to customers. Defects detected at that point may be difficult or expensive to resolve.

Various techniques have been employed to express design rules formally and keep them updated. Some conventional design rules treat states associated with objects independently. As examples, these design rules may ensure that locks are acquired and then released in strict alternation; files are opened before reading and closed before exiting; memory is allocated before use and released before software termination; and so forth. Various tools exist to statically check source code for conformance with these practices. However, they conventionally do not enforce the rules at runtime (e.g., when the software executes) and relate to single objects (e.g., locks, file handles, memory, etc.). Other conventional design rules enable the expression of design rules involving multiple objects, but are unable to enforce the design rules automatically.

### SUMMARY

A software design rule system is provided. The software design rule system can employ a rule language that enables software developers to model valid interactions between multiple, inter-related objects; provide a rule verifier component that determines whether design rules achieve their intended purpose; and provide a rule enforcer component that determines whether the software complies with the specified rules. Software designers can provide design specifications using the rule language that the software design rule system employs. The rule language can specify a program that identifies “auxiliary states” associated with objects in the software that is being developed, transitions between the auxiliary states, and object invariants.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating components associated with the software design rule system in various embodiments.

FIG. 2 is a block diagram illustrating components associated with the software design rule system and interactions between them in various embodiments.

FIG. 3 is a block diagram illustrating state transitions for an object in accordance with a protocol.

FIG. 4 is a block diagram illustrating two protocols.

FIG. 5 is a flow diagram illustrating a bind_rules routine invoked by the software design rule system in some embodiments.

FIG. 6 is a flow diagram illustrating an emit_logic routine invoked by the software design rule system in some embodiments.

FIG. 7 is a flow diagram illustrating a generate_verify_rules routine invoked by the software design rule system in some embodiments.

FIG. 8 is a flow diagram illustrating a generate_action_predicate routine invoked by the software design rule system in some embodiments.

FIG. 9 is a flow diagram illustrating a generate_constraints routine invoked by the software design rule system in some embodiments.

FIG. 10 is a flow diagram illustrating an enforce_rules routine invoked by the software design rule system in some embodiments.

FIG. 11 is a flow diagram illustrating an generate_aspect routine invoked by the software design rule system in some embodiments.

FIG. 12 is a combination flow and block diagram illustrating use of aspects in some embodiments.

### DETAILED DESCRIPTION

A software design rule system is provided. In various embodiments, the software design rule system employs a rule language that enables software developers to model valid interactions between multiple, inter-related objects; provides a rule verifier component that determines whether design rules achieve their intended purpose; and provides a rule enforcer component that determines whether the software complies with the specified rules.

Software designers can provide design specifications using the rule language that the software design rule system employs. The rule language specifies a program that identifies “auxiliary states” associated with objects in the software that is being developed, transitions between the auxiliary states, and object invariants. The rule language can be the same programming language as the source code or a different programming language. The program the rule language specifies is bound to the software via triggers that cause the program to evaluate the rule transitions and object invariants. An auxiliary state is a state associated with an object that may be unavailable to other objects or components that consume or employ the object that the auxiliary state is associated with. A transition is a valid change between two auxiliary states. An object invariant is an object-oriented programming construct having a set of properties associated with an object wherein the properties are consistent despite changes to the object's state. The object invariant can depend on other objects such that when an object is updated, other objects that depend on the object that is updated reconcile the update to maintain their invariants. Software designers provide an invariant method that is associated with each object that requires a rule. When the software is executing, it invokes the provided invariant method so that the invariants can be evaluated or enforced.

A design rule can have four elements: (1) roles that identify objects; (2) an auxiliary state associated with each identified object, (3) actions that change the auxiliary state with preconditions over the auxiliary state that specify when an action can be executed; and (4) an object invariant relating to the auxiliary state. Actions manipulate the auxiliary state to establish and maintain the object invariant. The following provides an example: suppose an object O has an invariant O.Inv( ). The invariant O.Inv( ) checks various attributes, such as auxiliary states, and returns true if the invariant holds. When the software changes or invokes a method that affects the value of these attributes, the action causes the auxiliary states to be updated so that O.Inv( ) can return the correct value.

The software design rule system provides a role ObjWInv, which is an object with an invariant. Other objects that have an Inv( ) method can bind to this role. Objects that bind to the role provide an auxiliary state variable “inv” that initializes to false when the software starts. For every object, O, ObjWInv.(O.inv)==true implies that O.Inv( )==true. O.inv can be set to true after checking whether O.Inv( ) is set to true. If O.Inv( ) is not set to true, O.inv will also not be set to true. O's invariant can be invalidated whenever O's state changes.

In various embodiments, the software design rule system provides a rule complier component comprising a rule verifier component and a rule enforcer component. These components will now be discussed.

The rule verifier component generates “proof obligations” to check whether the actions of specified rules violate invariants. A proof obligation is a condition that an automated theorem prover must determine is satisfied to prove a theorem. The verifier component can generate proof obligations for various automated theorem provers, such as “Simplify.” Upon generating the proof obligations, the verifier component can invoke the automated theorem prover to determine whether the source code relating to the software satisfies the proof obligations. The rule verifier component can verify the rules statically, such as based on source code or object code before the software executes.

The rule enforcer component can use Aspect-Oriented Programming (AOP) to enforce rules at runtime, such as when the software executes. AOP can involve language changes that enable expressions to encapsulate logic that cuts across several modules, methods, functions, and so forth. AspectJ is an example of an AOP language. Expressions that are provided by AOP languages are termed “aspects.” Aspects can also include structural changes to classes (e.g., objects), such as the addition of object members. As an example, aspects can alter the behavior of an object that software implements. This alteration can occur at a “join point” that is specified using a “pointcut” expression. A join point is a logical point in running software where additional logic can be added. As an example, the beginning or end of a method associated with an object may be a logical join point. Other examples of join points in AspectJ include object constructor code, initialization code, property read and write methods, and exception handlers. The rule enforcer component can employ AspectJ (or other AOP language) to add logic at join points by specifying one or more pointcuts. The rule enforcer can add aspects at join points to enforce rules.

When the proof obligations are proved by automated theorem prover component to be valid and the aspects do not generate any assertions when the software executes, the software is known to satisfy the design specifications. If the software fails to match the design rules, either the rule verifier component or the rule enforcer component will detect this failure. Thus, the software design rule system automatically validates both the object invariants and whether the software follows the rules of the design specification.

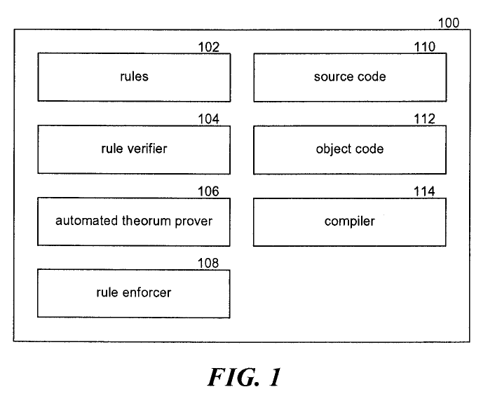

The software design rule system will now be described with reference to the figures. The FIG. 1 is a block diagram illustrating components associated with the software design rule system in various embodiments. The components may be implemented on one or more computing devices.

The computing devices on which the software design rule system operates may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the software design rule system. In addition, the data structures and message structures may be stored or transmitted via a data transmission medium, such as a signal on a communications link. Various communications links may be employed, such as the Internet, a local area network, a wide area network, or a point-to-point dial-up connection.

The software design rule system may use various computing systems or devices including personal computers, server computers, hand-held or laptop devices, multiprocessor systems, microprocessor-based systems, programmable consumer electronics, electronic game consoles, network PCs, minicomputers, mainframe computers, distributed computing environments that include any of the above systems or devices, and the like. The software design rule system may also provide its services to various computing systems, such as personal computers, cell phones, personal digital assistants, consumer electronics, home automation devices, and so on.

The software design rule system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In various embodiments, components associated with the software design rule system 100 can include one or more of the following: rules 102, rule verifier 104, automated theorem prover 106, rule enforcer 108, source code 110, object code 112, and compiler 114. The software design rule system can function with a subset of these components or with other components that are not illustrated or described herein. A rule can be a design rule. The rule can be expressed in various human-readable or machine-readable forms and can include one or more of the following: (1) roles that identify objects; (2) an auxiliary state associated with each identified object, (3) actions that change the auxiliary state with preconditions over the auxiliary state that specify when an action can be executed; and (4) an object invariant relating to the auxiliary state. A rule verifier component can determine whether design rules achieve their intended purpose. An automated theorem prover can be employed by the rule verifier to make some of these determinations, such as by analyzing proof obligations the rule verifier component emits. A rule enforcer component can determine whether software complies with the specified rules. The software design rule system may employ a compiler to transform source code into object code and associate aspects with the object code.

In some embodiments, the rules and source code may be combined so that the design rules form a portion of the source code for software.

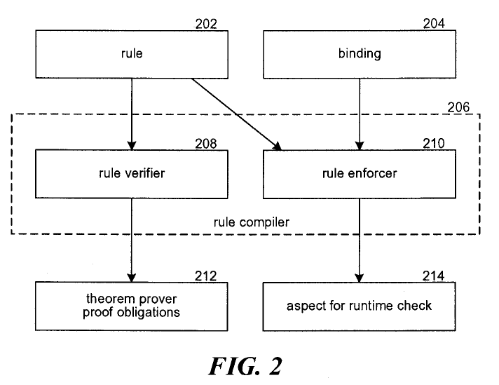

FIG. 2 is a block diagram illustrating components associated with the software design rule system and interactions between them in various embodiments. A rule 202 (e.g., design rule) is a program defining auxiliary states for objects of the software that is being designed. The rules are connected to the software via a binding 204 that triggers actions in the rule. The rule provides an invariant attribute for each object in the software that the rule associates with. This invariant attribute indicates whether the associated object satisfies its invariant. When the object or its dependent objects are updated, the rule causes an action to be triggered that updates the invariant attribute appropriately. A rule compiler 206 comprises a rule verifier 208 and a rule enforcer 210. The rule verifier and rule enforcer components were described above in relation to FIG. 1. Both the rule verifier and the rule enforcer employ the rules, such as to generate proof obligations 212 or aspects 214. The rule verifier generates proof obligations, such as to verify rules during compile time or design time. The rule enforcer employs the binding with the rules to generate aspects, such as for checking the software during runtime.

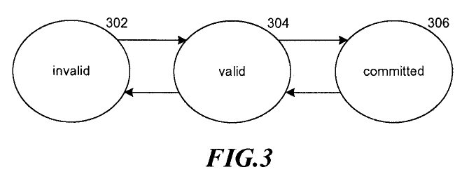

FIG. 3 is a block diagram illustrating state transitions for an object in accordance with a protocol. Suppose a merchandise order is valid if it contains an ordered item and that item has not been assigned to another merchandise order. O can represent the merchandise order and P can represent the ordered item. If O does not contain a valid P or if P is also assigned to another order O′, then O would be invalid. Thus, the same item cannot be a part of two merchandise orders. This condition is an invariant for O. One way to model the states of this protocol is illustrated in FIG. 3. The protocol relates to two dependent objects in which each object can have an invalid state 302, valid state 304, and committed state 306. For O to be valid in this protocol, P must be committed (e.g., the ordered item must be committed to the merchandise order). Table 1 specifies a rule relating to the protocol illustrated in FIG. 3.

TABLE 1

| Section | Rule Specification |
|---|---|
| Header | rule Protocol1 { |
| Definitions | enum State {Invalid, Valid, Committed}; |
| Invariant variable | //inv is built-in |
| initialization | boolean ObjWInv.inv := false; |
| Auxiliary states | State ObjWInv.st := State.Invalid; |
| | Set<ObjWInv> ObjWInv.comp := nullset; |
| Actions | Invalidate(ObjWInv p) { |
| | assert p.st = State.Invalid; |
| | p.inv := false; |
| | } |
| | Own(ObjWInv o, ObjWInv p) { |
| | assert o.st = State.Invalid; |
| | o.comp.Add(p); |
| | } |
| | Giveup(ObjWInv o, ObjWInv p) { |
| | assert o.st = State.Invalid; |
| | o.comp.Remove(p); |
| } | |
| | [noassumption] |
| | Pack(ObjWInv o) { |
| | assert o.st = State.Invalid; |
| | setInv(o); |
| | for(p in o.comp) { |
| | assert p.st = State.Valid; |
| | p.st := State.Committed; |
| | } |
| | o.st := State.Valid; |
| | } |
| | Unpack(ObjWInv o) { |
| | assert o.st = State.Valid; |
| | o.st := State.Invalid; |
| | for(p in o.comp) |
| | p.st := State.Valid; |
| | } |
| | IsNotInvalid(ObjWInv o) { |
| | assert o.st != State.Invalid; |
| | } |
| Invariant | invariant (forall o : ObjWInv :: |
| | o.st = State.Invalid \|\| |
| | (o.inv && |
| | (forall p : ObjWInv :: |
| | P in o.comp ==> |
| | p.st = State.Committed))); |
| Footer | } |

The Invariant variable initialization section may be provided by a software designer who specifies the design for the software. The remaining sections may be provided by a software developer who implements the design in code.

In the Auxiliary states section, this rule adds properties “st” and “comp” as auxiliary state properties to every object bound to the role ObjWInv, in addition to the built-in property “inv” which ObjWInv provides. The “st” property indicates whether the associated project is Invalid, Valid, or Committed. Objects associated with an object, O, are elements of the set O.comp.

In the Actions section, this rule provides six actions: Invalidate, Own, Giveup, Pack, Unpack, and IsNotInvalid. These actions can update one or more auxiliary states of the object with which the rule relates or can update other objects. Invalidate takes an object and sets its “inv” attribute to false. Own takes objects 0 and P and adds P to O.comp after asserting that O is Invalid. Giveup takes objects 0 and P and removes P from O.comp after asserting that O is invalid. Pack takes object O and makes it valid by using a setInv macro that asserts O.Inv before setting O.inv to true. Pack also transitions every element P in O.comp from the valid to committed states. P For P to be valid during Pack(O), Pack(P) should already have been invoked and object P should not be in the committed state. This ensures that object P is committed to a unique owner object O (e.g., the item should only correspond to a single merchandise order.) Unpack takes object O and causes it to go to the invalid state and causes every object P listed in O.comp to go to the valid state. IsNotInvalid takes object O and asserts that object O is not invalid. This method can be invoked to verify that object O is read only when its invariant is true. These actions can ensure that the objects' states are correct.

The Invariant section contains an object invariant. It states that an object O is either (1) invalid or (2) its invariant holds and all objects included in O.comp are in the committed state.

The rule verifier component can compile an object invariant into a predicate relating to the auxiliary state of the object and the actions are compiled into a predicate relating to a pair of auxiliary states (e.g., pre- and post-states) associated with the object. For an action A specified by a design rule, the rule verifier component can generate the following action predicate:

A(S₁,S₂)

This action predicate moves an object from a first state to a second state. The rule verifier component can generate this action predicate from an abstract syntax tree (e.g., parse tree) that it can create from the design rule.

The rule verifier component generates the following proof obligation for each object invariant I and action A:

∀(S₁,S₂).I(S₁)̂A(S₁, S₂)→I(S₂)

For actions that are tagged “noassumption,” such as the Pack action in Table 1, the rule verifier component generates the following proof obligation:

∀(S₁,S₂).A(S₁,S₂)→I(S₂)

Proof obligations can be expressed in a language that an automated theorem prover can interpret. The following expression that the “Syntax” automated theorem prover can interpret corresponds to the protocol described above:

### (DEFPRED (INVALIDATE S1 S2) . . . )

### (DEFPRED (INVARIANT S) . . . )

### (FORALL (S1 S2)

(IMPLIES (AND(INVARIANT S1)(INVALIDATE S1 S2))
(INVARIANT S2)))

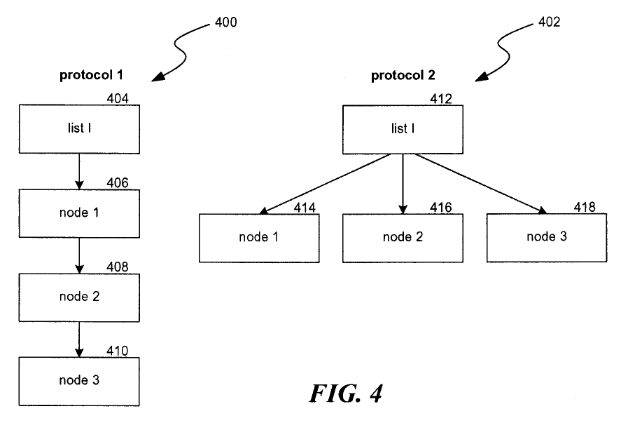

FIG. 4 is a block diagram illustrating two protocols. A first protocol 400 illustrates a design specification indicating that an object 404 may transition state nodes 406, 408, and 410. However, software may instead implement an alternate protocol 402 in which object 412 can transition to any state 414, 416, or 418. The software design rule system attempts to verify and enforce state transitions specified by the design rule to prevent this from occurring. Methods the software design rule system implements in various embodiments to prevent this problem will now be described.

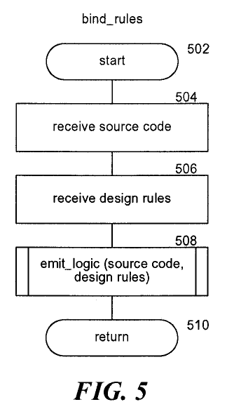

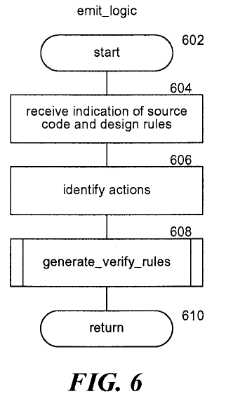

FIG. 5 is a flow diagram illustrating a bind_rules routine invoked by the software design rule system in some embodiments. The routine begins at block 502. At block 504, the routine receives source code. At block 506, the routine receives design rules. At 508, the routine invokes an emit_logic subroutine and may provide an indication of the received source code and design rules to the subroutine. The emit_logic subroutine is described in further detail below in relation to FIG. 6. At block 510, the routine returns.

Those skilled in the art will appreciate that the logic illustrated in FIG. 5 and described above, and in each of the flow diagrams discussed below, may be altered in a variety of ways. For example, the order of the logic may be rearranged, substeps may be performed in parallel, illustrated logic may be omitted, other logic may be included, etc.

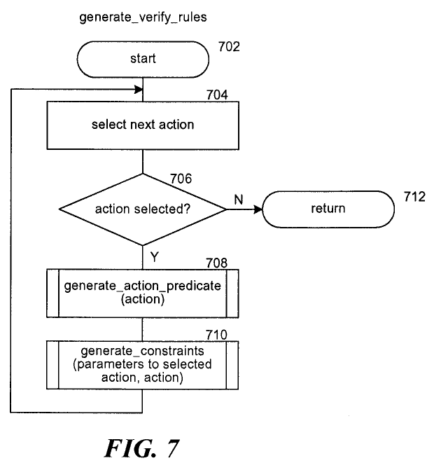

FIG. 6 is a flow diagram illustrating an emit_logic routine invoked by the software design rule system in some embodiments. The routine begins at block 602. At block 604, the routine receives an indication of source code and design rules. At block 606, the routine identifies actions based on the design rules. At block 608, the routine invokes a generate_verify_rules subroutine. The generate_verify_rules subroutine is described in further detail below in relation to FIG. 7. At block 610, the routine returns.

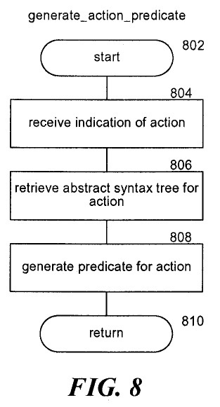

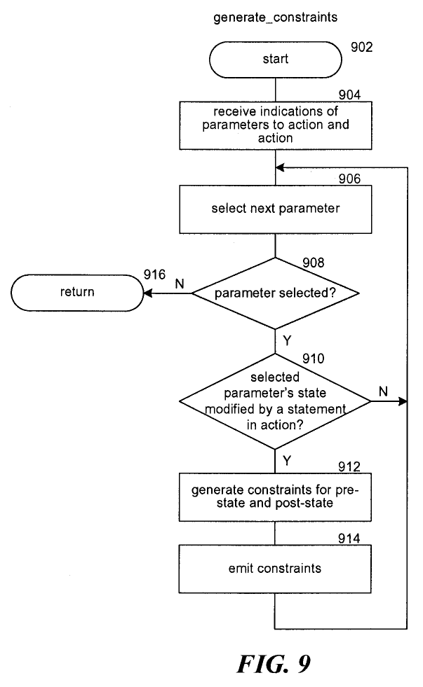

FIG. 7 is a flow diagram illustrating a generate_verify_rules routine invoked by the software design rule system in some embodiments. The routine begins at block 702. At block 704, the routine selects an action, such as from a list of actions generated by the emit_logic routine described above in relation to FIG. 6. At decision block 706, the routine determines whether an action was selected at block 704. As an example, when no actions are available or all actions have been processed, the routine continues at block 712 where it returns. Otherwise, the routine continues at block 708, where it invokes a generate_action_predicate subroutine and may provide an indication of the selected action to the subroutine. The generate_action_predicate subroutine is described in further detail below in relation to FIG. 8. At block 710, the routine generates constraints by invoking a generate_constraints subroutine and may provide indications of parameters to the selected action and the action to the subroutine. The generate_constraints subroutine is described in further detail below in relation to FIG. 9. The routine then continues at block 704.

FIG. 8 is a flow diagram illustrating a generate_action_predicate routine invoked by the software design rule system in some embodiments. The routine begins at block 802. At block 804, the routine receives an indication of an action. At block 806, the routine retrieves an abstract syntax tree for the indicated action. At block 808, the routine generates a predicate for the action. At block 810, the routine returns.

FIG. 9 is a flow diagram illustrating a generate_constraints routine invoked by the software design rule system in some embodiments. The routine begins at 902. At block 904, the routine receives indications of parameters to the action and the action. At block 906, the routine selects a parameter. At decision block 908, the routine determines whether all parameters have been processed. If no parameters could be selected at block 906, the routine may determine that all parameters have been processed. When that is the case, the routine continues at block 916 where it returns. Otherwise, when a parameter has been selected, the routine continues at decision block 910. At decision block 910, the routine determines whether the selected parameter's state is modified by a statement in the action. If that is the case, the routine continues at block 912. Otherwise, the routine continues at block 906. At block 912, the routine generates constraints for a “pre-state” and a “post-state”.

At block 914, the routine emits the generated constraints. The routine can emit constraints by binding objects in the software to a role in the design rule. This may be done by requiring the object to implement an interface corresponding to the role. Actions in the design rule can be triggered when execution of the software reaches various “join points.” A “pointcut” is a construct of an AOP language that selects join points and collects context (e.g., caller, parameters, etc.) at the join points. An “advice” is code that executes at a join point corresponding to a pointcut. The rule enforcer component triggers rule actions by providing advices at these join points. The rule enforcer component can provide the following binding for the protocol described above in relation to FIG. 3:

```
binding Protocol1 {
    declare parents: Laptop implements ObjWInv;
    declare parents: Order implements ObjWInv;
    //built-in: change (not shown)
    pointcut create(ObjWInv o) :
      (initialization(Laptop.new(..)) ||
      initialization(pg1.Order.new(..))) && this(o);
    pointcut read(ObjWInv o) :
      call(public int Laptop.getOrderId( )) && target(o);
    pointcut update(ObjWInv o) :
      (call(public void Laptop.setOrderId(int)) ||
        call(public void Order.process(pg1.Laptop))) && target(o);
    pointcut updateRepField(ObjWInv o, ObjWInv p) :
      (set(private Laptop Order.myLaptop) ||
      set(private boolean Order.processed) ||
      set(private int Order.id)) && target(o) && args(p);
    after(ObjWInv o) : create(o) {
      Pack(o);
    }
    before(ObjWInv o, ObjWInv p) : updateRepField(o,p) {
      //field.val is a convenient way of accessing the current value
of the updated field in the binding
      Giveup(o, o.field.val);
    }
    after(ObjWInv o, ObjWInv p) returning : updateRepField(o,p) {
      Own(o, p);
    }
    before(ObjWInv o) : read(o) {
      IsNotInvalid(o);
    }
    before(ObjWInv o) : update(o) {
      Unpack(o);
    }
    after(ObjWInv o) : update(o) {
      Pack(o);
    }
    //after change, invalidate(o) (not shown)
}
```

This binding identifies multiple pointcuts: create, read, update, and updateRepField. The create pointcut relates to the initialization of objects Order (e.g., a merchandise order) and Laptop (e.g., an ordered item). The change pointcut relates to state changes of object O. The design rule's binding adds pointcuts read, update, and updateRepField. The “after create” section of this binding provides an “advice” that is associated with a design rule action that is tagged as “noassumption,” such as the Pack action illustrated in Table 1. In this binding, Pack(O) could be invoked after object O is created. The “after change” advice invokes Invalidate(O) when object O's state changes. The “before read” advice verifies that object O is not invalid by invoking IsNotInvalid(O). The “before update” advice unpacks object O. The “after update” advice packs object O.

After emitting the constraints, the routine continues at block 906.

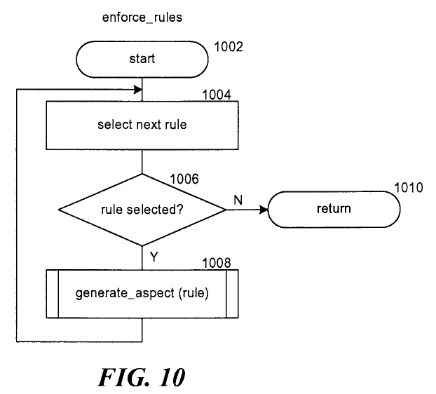

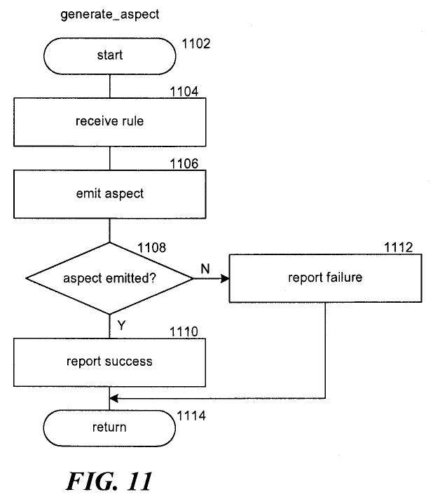

FIG. 10 is a flow diagram illustrating an enforce_rules routine invoked by the software design rule system in some embodiments. The routine begins at block 1002. At block 1004, the routine selects a rule. At decision block 1006, the routine determines whether all rules have been processed. If all rules have been processed, no rules would be selectable at block 1004. If no rules could be selected, the routine continues at block 1010, where it returns. Otherwise, the routine continues at block 1008 where it invokes a generate_aspect subroutine and may provide an indication of the selected rule to the subroutine. The generate_aspect subroutine is described in further detail below in relation to FIG. 11. The routine then continues at block 1004.

FIG. 11 is a flow diagram illustrating a generate_aspect routine invoked by the software design rule system in some embodiments. The routine begins at block 1102. At block 1104, the routine receives a rule. At block 1106, the routine invokes an aspect enforcement tool and may provide an indication of the received rule to the aspect enforcement tool. At decision block 1108, the routine determines whether the aspect enforcement tool returned successfully. If that is the case, the routine continues at block 1110. Otherwise, the routine reports a failure at block 1112. At block 1110, the routine reports a success. After performing the logic associated with blocks 1110 or 1112, the routine continues at block 1114, where it returns.

For a given rule and binding, the software design rule system emits an aspect. The aspect is bound to software via a binding at one or more pointcuts. When the software's execution arrives at the pointcut, the logic associated with the aspect (e.g., one or more advices) is executed. The aspects or advices can be related to the software by an AOP compiler, such as AspectJ. The aspect may have a role ObjWInv that is represented with an interface. Classes (e.g., objects) that implement this interface implement an Inv( ) method. An auxiliary state can be represented as fields of a private class ObjWInvAuxState. These fields are accessible to methods of the aspect:

private class ObjWInvAuxState {
public boolean inv = false;
public boolean accessed = true;
public ObjWInv owner = null;
}

An object O that binds to the role ObjWInv and its auxiliary state can be kept in a “map.” The map refers to objects via a “weak” reference so that garbage collection is not impacted. The mapping can also employ “reference equality” instead of “object equality” for comparisons so that each unique instance of object O has a separate copy of auxiliary states. In various embodiments, each action in the design rule is mapped to function in the aspect. Functions in aspects access auxiliary states via a getObjWInvAuxState(O) function. As an example, the software design rule system can implement the action Own(O,P) as follows:

```
Own(ObjWInv o, ObjWInv p) {
    assert o.accessed = true;
    assert p.owner = null;
    p.accessed := true;
    p.owner := o;
}
private void Own(ObjWInv o, ObjWInv p) {
    ObjWInvAuxState ostate = getObjWInvAuxState(o);
    assert ostate.accessed == true;
    ObjWInvAuxState pstate = getObjWInvAuxState(p);
    assert pstate.owner == null;
    pstate.accessed = true;
    pstate.owner = o;
}
```

A method that accesses an auxiliary state's field (e.g., O.f) is translated as follows: (1) the function getObjWInvAuxState(O) is invoked to retrieve the object's ostate property that stores the auxiliary state for O, and (2) the field ostate.f is accessed. The binding is attached to the generated aspect.

To retrieve the current value of a field, the software design rule system employs reflection. The software design rule system can employ AOP techniques to check that O.Inv( ) can neither modify the state of an object nor trigger a design rule's action. The software design rule system may also employ AOP techniques to compute dependency relations so that any “get” operation on an object P during execution of O.Inv( ) is captured in a pointcut. The software design rule system may add the (O,P) association to the dependency relations.

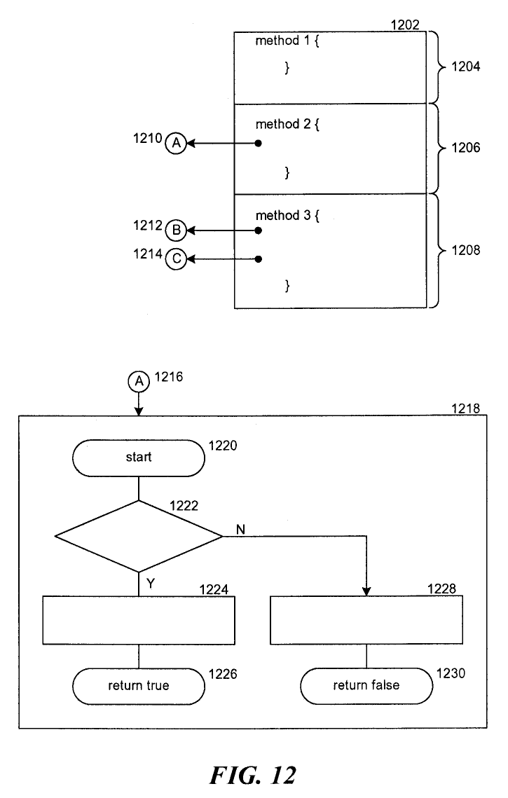

FIG. 12 is a combination flow and block diagram illustrating use of aspects in some embodiments. Object code 1202 that is emitted by a compiler may include methods 1204, 1206, and 1208. Method 1 1204 has no associated aspect, but method 2 1206 is associated with an aspect 1210 and method 3 1208 is associated with aspects 1212 and 1214. Each aspect can have associated object code that the rule compiler connects to the object code 1202, such as at pointcuts. As an example, the logic 1218 connects via pointcut 1216 to method 2 1206. The logic 1218 is implemented by aspect 1210. The logic of the aspect (e.g., advice) can be varied. It can start 1220, evaluate a condition 1222, and take actions 1224 or 1228 based on the condition. The aspect can also return values, such as true 1226 or false 1230, thereby enforcing the design rules.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computer system for verifying and enforcing design rules, comprising:
receiving source code specifying software, the source code implementing at least two inter-related objects;
receiving a design rule specified in a design rule language that models valid interactions between the two inter-related objects;
interpreting the received design rule to produce a proof obligation, the proof obligation including a condition;
determining whether the source code implements the design rule correctly by causing the condition of the proof obligation to be evaluated;
emitting a constraint based on the design rule, the constraint analyzing an invariant of the object;
producing object code based on the received source code; and
causing the emitted constraint to be bound to object code so that the object code enforces the received design rule.

2. The method of claim 1 wherein the interpreting includes identifying auxiliary states associated with the two inter-related objects.

3. The method of claim 1 further comprising identifying auxiliary states associated with the two inter-related objects, transitions between the identified auxiliary states, and an object invariant associated with one of the two inter-related objects.

4. The method of claim 1 wherein the emitted constraint is bound to the object code via a trigger at a pointcut of the object code.

5. The method of claim 1 wherein the design rule includes a role, an auxiliary state associated with the two inter-related objects, an action that changes the auxiliary state, and an object invariant associated with the auxiliary state.

6. The method of claim 5 wherein the object invariant does not change when the auxiliary state changes.

7. The method of claim 5 wherein the role implements an invariant.

8. The method of claim 1 wherein the design rule language is a different programming language than a language in which the source code is implemented.

9. The method of claim 1 further comprising enforcing the design rule when the object code executes.

10. The method of claim 9 wherein the enforcing includes evaluating an invariant associated with the emitted constraint.

11. The method of claim 9 wherein the enforcing includes evaluating using an aspect oriented programming technique an invariant associated with the emitted constraint wherein the emitted constraint is an advice associated with an aspect, the aspect specified in an aspect oriented programming language.

12. The method of claim 1 further comprising adding an object to the software specified by the received source code based on the received design rule.

13. A system for verifying and enforcing design rules, comprising:
a rule providing a design specification for software;
a source code file providing code for the software;
a rule verifier component that emits a proof obligation based on the rule;
an automated theorem prover component that evaluates the proof obligation to determine whether the source code satisfies the design specification;
a compiler that produces object code based on the source code; and
a rule enforcer component that produces a constraint to be bound to the object code so that the provided design specification is enforced when the produced object code executes.

14. The system of claim 13 wherein the rule is provided in a design rule language.

15. The system of claim 13 wherein the rule enforcer component and the rule verifier component operate jointly as a rule compiler to interpret the rule.

16. The system of claim 15 wherein the rule compiler adds an object to the software that is not included in the source code.

17. The system of claim 13 wherein the constraint is bound to the object code at a join point of the object code and is associated with an aspect that is defined based on the rule.

18. A computer-readable medium storing computer-executable instructions that, when executed, cause a computer system to perform a method for verifying and enforcing design rules, the method comprising:
identifying an action;
generating a proof obligation for the identified action;
determining whether a state of a parameter to the action is modified by a statement in the action;
when a state of a parameter to the action is modified by a statement in the action, generating constraints; and
emitting the generated constraints.

19. The computer-readable medium of claim 18 further comprising binding the emitted constraints to an aspect associated with a join point in an object code.

20. The computer-readable medium of claim 19 further comprising invoking an advice identified by the aspect when execution of the object code arrives at the join point.
